(19) United States
(12) Patent Application Publication
(10) Pub. No.: US 2012/0274554 A1
(43) Pub. Date: Nov. 1, 2012

(54) BODY MOVEMENT DETECTION DEVICE AND DISPLAY CONTROL METHOD OF BODY MOVEMENT DETECTION DEVICE

(75) Inventors: Shigeo KINOSHITA, Dalian (CN); Naoki TAKEISHI, Osaka (JP)

(73) Assignee: OMRON HEALTHCARE CO., LTD., Muko-shi (JP)

(21) Appl. No.: 13/542,338

(22) Filed: Jul. 5, 2012

Related U.S. Application Data
(63) Continuation of application No. PCT/JP2011/053510, filed on Feb. 18, 2011.

(30) Foreign Application Priority Data
Mar. 1, 2010 (JP) 2010-044363

(51) Int. Cl. G09G 5/00

(52) U.S. Cl. 345/156

(57) ABSTRACT

A body movement detection device is provided with a main body unit, a display unit provided to the main body unit, a control unit, and a detection unit that detects acceleration of the main body unit, and the control unit includes a discriminating unit for discriminating a movement state of a user wearing the main body unit based on the acceleration detected by the detection unit, and a display control unit for switching a display state of the display unit based on discrimination of the movement state by the discriminating unit. Display can thereby be automatically switched to display appropriate to the state of physical activity.

### TECHNICAL FIELD

The invention relates to a body movement detection device and a display control method of the body movement detection device, and more particularly to a body movement detection device suitable for performing display appropriate to the situation and a display control method of the body movement detection device.

### BACKGROUND ART

Conventional pedometers, activity monitors and the like are configured to display indices that a user selects with a button operation, irrespective of the state of physical activity. The indices that the user wants to view differ depending on the state of physical activity, such as wanting to view step count and time when walking and wanting to view burned calories and pitch when jogging, for example. The user thus needs to perform a button operation each time in the case of switching to display appropriate to the state of physical activity.

JP 2006-271893A (hereinafter “Patent Literature 1”) discloses a technique for determining the content of physical activity from acceleration, and calculating the amount of physical activity according to that physical activity.

### CITATION LIST

### Patent Literature

Patent Literature 1: JP 2006-271893A

### SUMMARY OF INVENTION

### Technical Problem

However, even in the case where the technique of Patent Literature 1 is used, there is a problem in that the user needs to perform a button operation in the case of switching to display appropriate to the state of physical activity.

The present invention was made in order to solve the abovementioned problems, and one object thereof is to provide a body movement detection device capable of switching display automatically based on a movement state and a display control method of the body movement detection device.

### Solution of Problem

In order to attain the abovementioned object, according to an aspect of this invention, a body movement detection device includes a main body unit, a display unit provided to the main body unit, a control unit, and a detection unit that detects acceleration of the main body unit, the control unit including a discriminating unit that discriminates a movement state of a user wearing the main body unit, based on the acceleration detected by the detection unit, a display control unit that switches a display state of the display unit, based on discrimination of the movement state by the discriminating unit, and a detecting unit that detects a change by the user to a prescribed posture for viewing the display unit, based on the acceleration detected by the detection unit. The discriminating unit discriminates that the movement state has changed, when a change to the prescribed posture is detected by the detecting unit. The display control unit switches the display state of the display unit in a case where it is discriminated by the discriminating unit that the movement state has changed.

According to this invention, the movement state of a user who is wearing the main body unit is discriminated by the body movement detection device based on the detected acceleration, the display state of the display unit is switched based on the discriminated movement state, and a change by the user to the prescribed posture for viewing the display unit is detected based on the detected acceleration. The movement state of a user who is wearing the main body unit is discriminated by the body movement detection device based on the detected acceleration. A change in the movement state is discriminated when a change to the prescribed posture is detected, and the display state of the display unit is switched in the case where a change in the movement state is discriminated.

As a result, a body movement detection device capable of switching display automatically based on the movement state can be provided. Also, display can be switched automatically when the movement state changes. Display can be switched automatically when the user makes a move to look at the display.

Preferably, the detecting unit further detects a change from the prescribed posture to another posture, based on the acceleration detected by the detection unit, and the display control unit further switches the display state to a non-display state, when a change to the other posture is detected by the detecting unit.

According to this invention, a change from the prescribed posture to another posture is detected by the body movement detection device based on the detected acceleration, and the display state is switched to a non-display state when a change to the other posture is detected.

As a result, the display state can be switched to a non-display state when the user finishes viewing the display.

Preferably, the detecting unit further detects acceleration in a direction in which an influence of gravitational acceleration is greater when the user is in the prescribed posture than when the user is in another posture, and the detecting unit detects a change to the prescribed posture, when the acceleration detected by the detection unit satisfies a condition enabling it to be judged that the influence of gravitational acceleration is greater.

According to this invention, acceleration in a direction in which the influence of gravitational acceleration is greater when the user is in the prescribed posture than when the user is in another posture is detected by the body movement detection device, a change to the prescribed posture is detected when the detected acceleration satisfies a condition enabling it to be judged that the influence of gravitational acceleration is greater, a change in the movement state is discriminated when a change to the prescribed posture is detected, and the display state of the display unit is switched in the case where a change in the movement state is discriminated.

A change to the prescribed posture can thus be detected by judging the degree to which gravitational acceleration influences the detected acceleration.

Preferably, the detection unit detects acceleration in two or three axis directions, and the detecting unit detects a change to the prescribed posture, when a condition enabling it to be judged that a representative value of combined acceleration obtained by combining the acceleration in the two or three axis directions detected by the detection unit is less than a prescribed value is satisfied.

According to this invention, acceleration in two or three axis directions is detected by the body movement detection device, a change to the prescribed posture is detected when a condition enabling it to be judged that a representative value of combined acceleration obtained by combining the detected accelerations in two or three axis directions is less than a prescribed value is satisfied, a change in the movement state is discriminated when a change to the prescribed posture is detected, and the display state of the display unit is switched in the case where a change in the movement state is discriminated.

In the case where the user is undertaking a given physical activity, the arm on which the main body unit of the body movement detection device is being worn will move less when the user is in the prescribed posture for viewing the display unit as compared to when the user is not in the prescribed posture, and thus it is thought that the combined acceleration of detected acceleration will be reduced. A change to the prescribed posture can thus be detected by judging that the representative value of the combined acceleration is less than a prescribed value.

Preferably, the display control unit switches the display state of the display unit to a display state appropriate to the movement state discriminated by the discriminating unit.

According to this invention, the movement state of the user who is wearing the main body unit is discriminated by the body movement detection device based on the detected acceleration, and the display state of the display unit is switched to a display state appropriate to the discriminated movement state, based on the discriminated movement state. As a result, display can be switched automatically to display appropriate to the movement state, based on the movement state.

More preferably, the movement state is a state of physical activity, the discriminating unit discriminates a running state, a walking state or a stopped state as the state of physical activity, and the display control unit switches to display suitable for when the user is running in a case where the state of physical activity discriminated by the discriminating unit is the running state, switches to display suitable for when the user is walking in a case where the state of physical activity discriminated by the discriminating unit is the walking state, and switches to display suitable for when the user has stopped in a case where the state of physical activity discriminated by the discriminating unit is the stopped state.

According to this invention, display can be automatically switched to display suitable for a running state, a walking state or a stopped state, based on the movement state.

Preferably, the discriminating unit discriminates the movement state, according to a waveform of the acceleration.

According to another aspect this invention, a display control method of a body movement detection device is a display control method for switching a display state of a display unit of a body movement detection device that includes a main body unit, the display unit which is provided to the main body unit, a control unit and a detection unit that detects acceleration of the main body unit, the method including the steps of the control unit discriminating a movement state of a user wearing the main body unit, based on the acceleration detected by the detection unit, the control unit switching the display state of the display unit, based on discrimination of the movement state, and detecting a change by the user to a prescribed posture for viewing the display unit, based on the acceleration detected by the detection unit. The step of discriminating the movement state includes the step of discriminating that the movement state has changed, when a change to the prescribed posture is detected. The step of switching the display state includes the step of switching the display state of the display unit in a case where it is discriminated that the movement state has changed.

According to this invention, a display control method of a body movement detection device that enables display to be switching automatically based on the movement state can be provided. Also, display can be switched automatically when the movement state changes. Display can be switched automatically when the user makes a move to look at the display.

### BRIEF DESCRIPTION OF DRAWINGS

FIG. 1 is an external view of an activity monitor according to an embodiment of the invention.

FIG. 2A is a diagram showing the activity monitor in use according to the embodiment.

FIG. 2B is a diagram showing the activity monitor in use according to the embodiment.

FIG. 3 is a block diagram showing a schematic configuration of the activity monitor according to the embodiment.

FIG. 4 is a flowchart showing the flow of display processing executed by the activity monitor according to a first embodiment.

FIG. 5 is a flowchart showing the flow of physical activity detection processing executed by the activity monitor according to the first embodiment.

FIG. 6 is a flowchart showing the flow of posture change detection processing executed by the activity monitor according to the first embodiment.

FIG. 7 is a graph showing the change in acceleration in a use state of the activity monitor according to the first embodiment.

FIG. 8 is a flowchart showing the flow of posture change detection processing executed by the activity monitor according to a second embodiment.

FIG. 9 is a graph showing the change in combined acceleration in a use state of the activity monitor according to the second embodiment.

FIG. 10 is a flowchart showing the flow of posture change detection processing executed by the activity monitor according to a third embodiment.

### DESCRIPTION OF EMBODIMENTS

Hereinafter, embodiments of the invention will be described in detail with reference to the drawings. Note that the same reference numerals are given to the same or equivalent portions in the drawings, and description thereof will not be repeated.

The embodiments are described in terms of the body movement detection device being an activity monitor capable of measuring not only the number of steps but also the amount of activity that a user undertakes in physical activity, daily life and the like (e.g., vacuuming, light load carrying, cooking, etc.). However, the present invention is not limited thereto, and the body movement detection device may be a pedometer capable of measuring the number of steps.

### First Embodiment

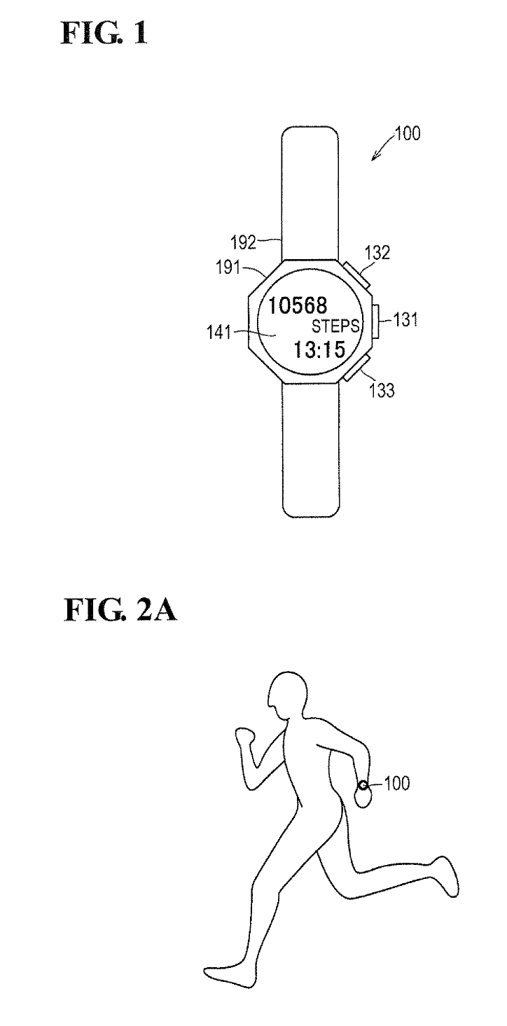

FIG. 1 is an external view of an activity monitor 100 according to an embodiment of the invention. Referring to FIG. 1, the activity monitor 100 is primarily constituted by a main body unit 191 and a band 192. The band 192 is used in order to fix the activity monitor 100 to the user's arm.

The main body unit 191 is provided with a change display/setting switch 131, an up-operation/memory switch 132 and a down-operation/delete switch 133 constituting part of an operation unit 130 which will be discussed later, and a display 141 constituting part of a display unit 140 which will be discussed later.

The display 141 is constituted by a liquid crystal display (LCD) in the present embodiment, but is not limited thereto and may be another type of display such as an electroluminescence (EL) display.

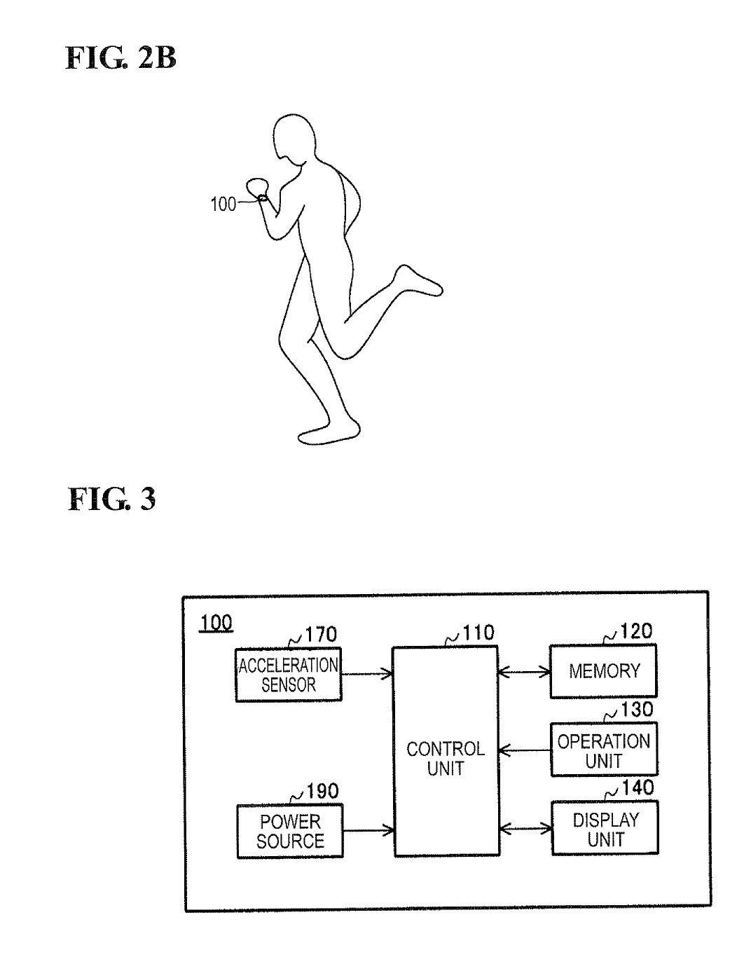

FIGS. 2A and 2B are diagrams showing the activity monitor 100 in use according to this embodiment. Referring to FIGS. 2A and 2B, the activity monitor 100 is, for example, worn on the user's wrist using the band 192.

FIG. 2A is a diagram showing a state in which the user is swinging the arm on which he is wearing the activity monitor 100 while jogging. FIG. 2B is a diagram showing a state in which the user has bent his arm and positioned the wrist on which he is wearing the activity monitor 100 in front of his body, in order to check the contents displayed on the display 141 of the activity monitor 100 while jogging.

FIG. 3 is a block diagram showing a schematic configuration of the activity monitor 100 in this embodiment. Referring to FIG. 3, the activity monitor 100 includes a control unit 110, a memory 120, the operation unit 130, the display unit 140, an acceleration sensor 170, and a power source 190. Also, the activity monitor 100 may be configured to include an interface for communicating with an external computer.

The control unit 110, the memory 120, the operation unit 130, the display unit 140, the acceleration sensor 170 and the power source 190 are incorporated into the main body unit 191 illustrated in FIG. 1.

The operation unit 130 includes the change display/setting switch 131, the up-operation/memory switch 132 and the down-operation/delete switch 133 illustrated in FIG. 1, and transmits operation signals indicating that these switches have been operated to the control unit 110.

The acceleration sensor 170 used may be a semiconductor sensor based on micro-electro-mechanical systems (MEMS) technology, but is not limited thereto, and may be another type of sensor such as a mechanical sensor or an optical sensor. The acceleration sensor 170, in the present embodiment, outputs detection signals indicating acceleration in each of three axis directions to the control unit 110. However, the acceleration sensor 170 is not limited to a triaxial sensor, and may be a single-axis or biaxial acceleration sensor.

Here, the three axis directions of the acceleration sensor 170 will be described. In this embodiment, the acceleration sensor 170 is incorporated in a wristwatch-type activity monitor 100, with the acceleration sensor 170 being incorporated such that, in a state in which the activity monitor 100 is worn on the user's wrist so that the display 141 is visible with the main body unit 191 on the back of the left arm (FIGS. 2A and 2B), the X-axis direction of the acceleration sensor 170 is the direction of the portion connecting the main body unit 191 and the band 192 on the little finger side as viewed from the main body unit 191 (in other words, the 12 o'clock direction assuming the display 141 has a watch face), the Y-axis direction is the direction of the fingertips as viewed from the main body unit 191 (in other words, the 3 o'clock direction assuming the display 141 has a watch face), and the Z-axis direction is the direction inward of the wrist as viewed from the main body unit 191.

The memory 120 includes a nonvolatile memory such as read-only memory (ROM; e.g., flash memory), and a volatile memory such as random access memory (RAM; e.g., synchronous dynamic random access memory (SDRAM)).

The memory 120 stores the data of programs for controlling the activity monitor 100, data used in order to control the activity monitor 100, setting data for setting the various functions of the activity monitor 100, and measurement result data per prescribed time period (e.g., daily) such as number of steps and amount of activity. The memory 120 is also used as a work memory when programs are executed.

The control unit 110 includes a central processing unit (CPU), and, in accordance with the programs for controlling the activity monitor 100 stored in the memory 120, controls the memory 120 and the display unit 140 based on detection signals from the acceleration sensor 170, in response to operation signals from the operation unit 130.

The display unit 140 includes the display 141 illustrated in FIG. 1, and controls the display 141 to display prescribed information adhering to control signals from the control unit 110.

The power source 190 includes a replaceable battery, and supplies power from the battery to components of the activity monitor 100 that require power to operate such as the control unit 110,

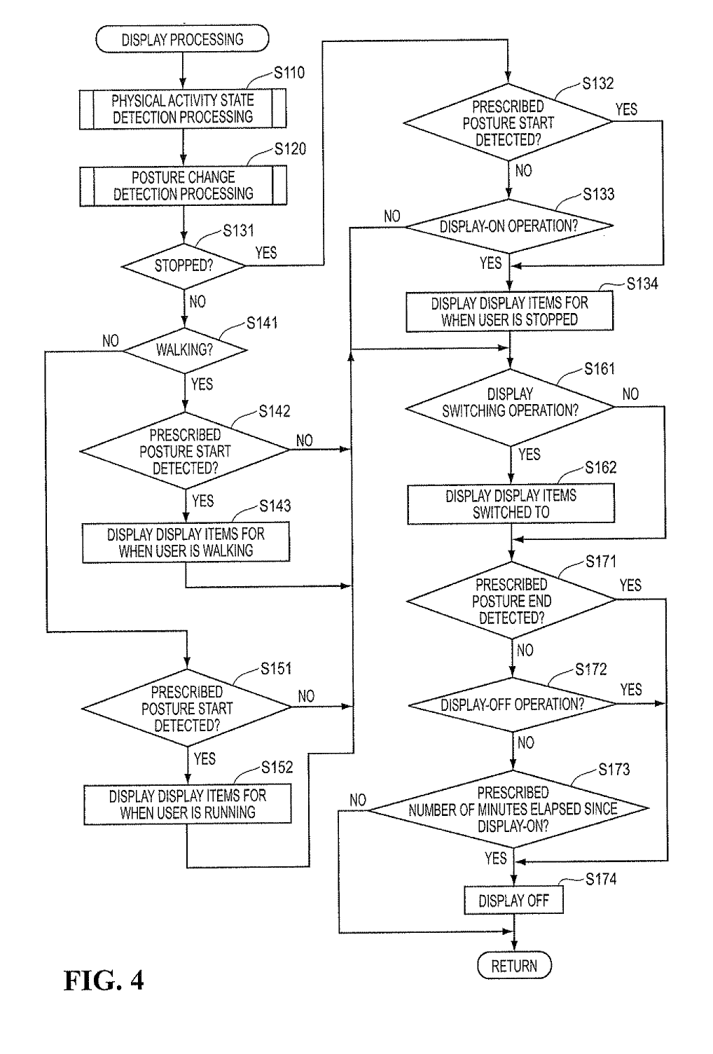

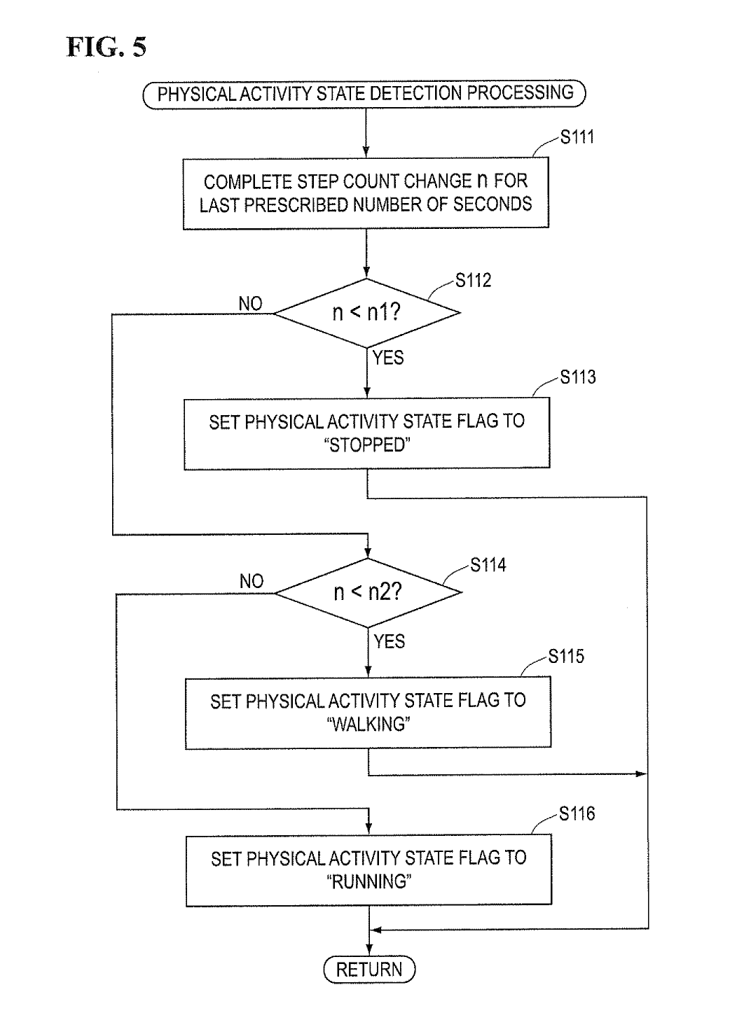

FIG. 4 is a flowchart showing the flow of display processing executed by the activity monitor 100 according to the first embodiment. Referring to FIG. 4, at step S110, the control unit 110 executes physical activity state detection processing. FIG. 5 is a flowchart showing the flow of physical activity state detection processing executed by the activity monitor 100 according to the first embodiment.

Referring to FIG. 5, at step S111, the control unit 110 computes a step count change n for the last prescribed number of seconds (in the present embodiment, 5 seconds), based on detection values from the acceleration sensor 170. Specifically, the step count change n can be calculated by counting the number of peaks taking local maximum values among the changes in a graph of acceleration for the last prescribed number of seconds.

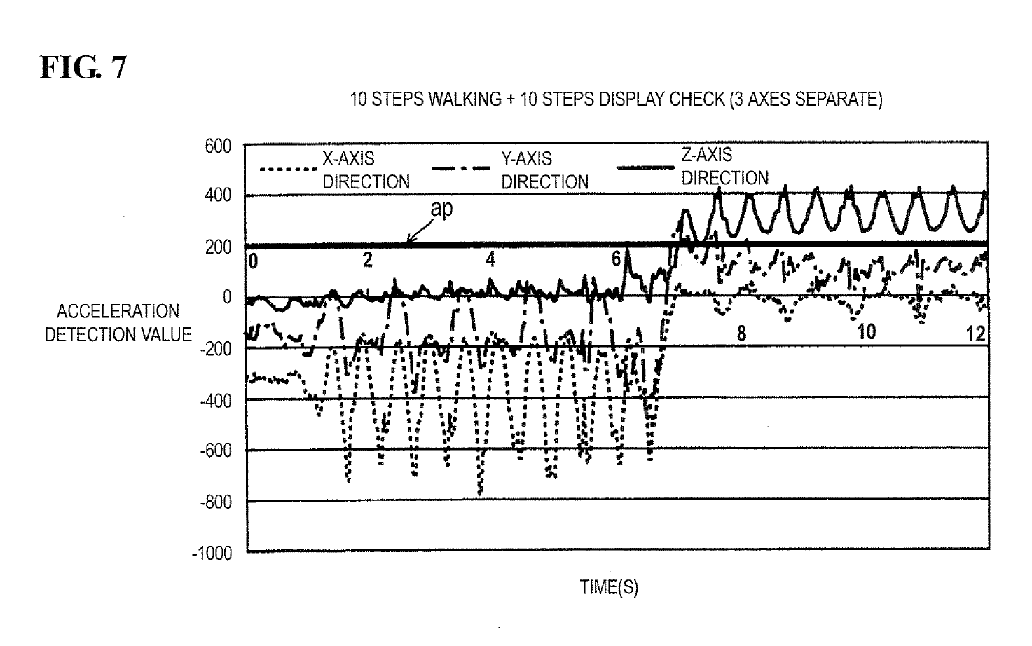

FIG. 7 is a graph showing the change in acceleration in the usage state of the activity monitor 100 in the first embodiment. Referring to FIG. 7, from 0 seconds to approximately 7 seconds is a graph showing the change in acceleration detection value for each of the three axis directions when the user is jogging without checking display on the display 141 of the activity monitor 100, as shown in the aforementioned FIG. 2A, and from 7 seconds onward is a graph showing the change in acceleration detection value for each of the three axis directions when the user is checking the display of the activity monitor 100 display 141 while jogging, as shown in the aforementioned FIG. 2B.

For example, the acceleration detection value in the X-axis direction takes local maximum values 9 times during the period from approximately 2 seconds to approximately 7 seconds, in which case, the step count change n for the last 5 seconds up to the point in time at which 7 seconds has elapsed is calculated to be approximately 9 steps.

Returning to FIG. 5, next the control unit 110, at step S112, judges whether the step count change n for the last prescribed number of seconds is less than a prescribed value n1 (in the present embodiment, 2 steps).

If it is judged that the step count change n for the last prescribed number of seconds is less than the prescribed value n1 (when judged YES at step S112), the control unit 110, at step S113, sets a physical activity state flag to a state indicating “stopped”. The physical activity state flag is a flag indicating the user's current state of physical activity. After step S113, the control unit ends the physical activity state detection processing, and returns to the display processing from which this processing was originally called.

On the other hand, if it is judged that the step count change n for the last prescribed number of seconds is not less than the prescribed value n1 (if judged NO at step S112), the control unit 110, at step S114, judges whether the step count change n for the last prescribed number of seconds is less than a prescribed value n2 (in the present embodiment, 15 steps).

If it is judged that the step count change n for the last prescribed number of seconds is less than the prescribed value n2 (if judged YES at step S114), the control unit 110, at step S115, sets the physical activity state flag to a state indicating “walking”. After step S115, the control unit ends this physical activity state detection processing, and returns to the display processing from which this processing was originally called.

On the other hand, if it is judged that the step count change n for the last prescribed number of seconds is not less than the prescribed value n2 (if judged NO at step S114), the control unit 110, at step S116, sets the physical activity state flag to a state indicating “running”. After step S116, the control unit ends this physical activity state detection processing, and returns to the display processing from which this processing was originally called.

In this way, as a result of the physical activity state detection processing being performed, the state of physical activity of the user is judged to be the “stopped” state if the number of steps for the last prescribed number of seconds (e.g., 5 seconds) is less than the prescribed value n1 (e.g., 2 steps), the state of physical activity of the user is judged to be the “walking” state if greater than or equal to the prescribed value n1 and less than the prescribed value n2 (e.g., 15 steps), and the state of physical activity of the user is judged to be the “running” state if greater than the prescribed value n2.

Note that although the state of physical activity of the user is one of the three states “stopped”, “walking” and “running” in this physical activity state detection processing, the present invention is not limited thereto, and the state of physical activity of the user may be one of the two states “stopped” or “walking”, or one of four or more states.

Also, although the state of physical activity was judged based on the step count change n of the user for the last prescribed number of seconds in this physical activity state detection processing, the present invention is not limited thereto, and the state of physical activity may judged based on the user's moving speed, or based on the degree of the change in acceleration, or based on the degree of the change in burned calories, or the state of physical activity may be calculated based on a MET value, where a MET is a unit representing the intensity of bodily activity (activity intensity) with a value equivalent to multiples of the activity intensity at rest, or based on an EX (exercise) value, where an EX is a unit representing an amount of bodily activity obtained by multiplying activity intensity (METs) by time.

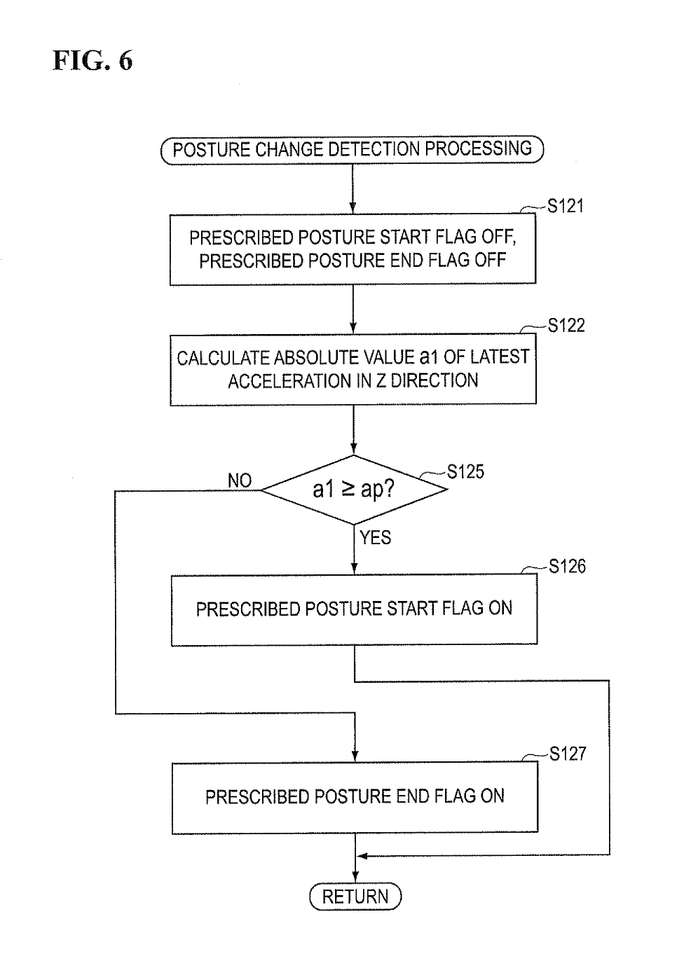

Returning to FIG. 4, after step S110, the control unit 110, at step S120, executes posture change detection processing. FIG. 6 is a flowchart showing the flow of posture change detection processing executed by the activity monitor 100 in the first embodiment.

Referring to FIG. 6, the control unit 110, at step S121, sets a prescribed posture start flag and a prescribed posture end flag to an OFF state. Here, the prescribed posture start flag is a flag that is set to an ON state when it is judged that the user has started the prescribed posture illustrated in FIG. 2B for checking the display of an activity monitor, and is set to OFF when this is not the case. The prescribed posture end flag is a flag that is set to ON when it is judged that user has ended the prescribed posture, and is set to OFF when this not the case.

At the following step S122, the control unit 110 calculates the absolute value a1 of the latest acceleration in the Z-axis direction, based on detection values from the acceleration sensor 170.

In a state where the user is swinging his arms when jogging without checking the contents displayed on the display 141 of the activity monitor 100, as shown in the aforementioned FIG. 2A, acceleration in the Z-axis direction will be little affected by the influence of gravitational acceleration because of the Z-axis direction being substantially orthogonal to the vertical direction.

On the other hand, in a state where the user checks the contents displayed on the display 141 of the activity monitor 100 when jogging, as shown in the aforementioned FIG. 2B, acceleration in the Z-axis direction will be affected by the influence of gravitational acceleration because of the Z-axis direction approaching a direction parallel to the vertical direction.

In the case where the absolute value of acceleration in the Z-axis direction is greater than or equal to a prescribed value ap at which it can be judged that the influence of gravitational acceleration has increased, it can thus be judged that the user has changed to the prescribed posture for viewing the display 141 of the activity monitor 100, as shown in the aforementioned FIG. 2B.

At step S125, the control unit 110 judges whether the absolute value a1 of the latest acceleration in the Z-axis direction is greater than or equal to the prescribed value ap (in the present embodiment, 200 in the detection values of the acceleration sensor 170 which is the index on the vertical axis of the graph of FIG. 7).

Proceeding to FIG. 7, it is clear that when the user is jogging without checking display on the display 141 of the activity monitor 100 from 0 seconds to approximately 7 seconds, the acceleration detection values in the Z-axis direction will be substantially zero or thereabouts, whereas when the user checks display on the display 141 of the activity monitor 100 while jogging from approximately 7 seconds onward, the absolute value a1 of the acceleration detection value in the Z-axis direction will be greater than or equal to the prescribed value ap (in the present embodiment, 200).

Note that in FIG. 7, an acceleration detection value 340 is a value equal to gravitational acceleration g (=9.80665m/s2).

Returning to FIG. 6, if it is judged that the absolute value a1 of acceleration in the Z-axis direction is greater than or equal to the prescribed value ap (if judged YES at step S125), the control unit 110, at step S126, sets the prescribed posture start flag to an ON state. Thereafter, the control unit 110 returns to the display processing from which this posture change detection processing was originally called.

If it is judged that the absolute value a1 of acceleration in the Z-axis direction is not greater than or equal to the prescribed value ap (if judged NO at step S125), the control unit 110, at step S127, sets the prescribed posture end flag to an ON state. Thereafter, the control unit 110 returns to the display processing from which this posture change detection processing was originally called.

Note that, here, it is judged whether the prescribed posture has started or ended, depending on whether the absolute value of the latest acceleration in the Z-axis direction is greater than or equal to a prescribed value. However, the present invention is not limited thereto, and a configuration may be adopted in which it is judged whether the absolute value of the average value of acceleration in the Z-axis direction for the last few cycles (e.g., one cycle (one step) or a plurality of cycles (plurality of steps)) is greater than or equal to a prescribed value.

Returning to FIG. 4, after step S120, the control unit 110, at step S131, judges whether the physical activity state flag of the user set at step S110 indicates “stopped”.

If it is judged that “stopped” is indicated (if judged YES at step S131), the control unit 110, at step S132, judges whether the prescribed posture start flag was set to an ON state at step S120, or in other words, whether the start of the prescribed posture has been detected.

If it is judged that the start of the prescribed posture has not been detected (if judged NO at step S132), the control unit 110, at step S133, judges whether an operation for setting display on the display 141 to an ON state has been performed, by judging whether an operation signal indicating that the change display/setting switch 131 was operated by the user has been input from the operation unit 130 to the control unit 110.

If it is judged that the start of the prescribed posture has been detected (if judged YES at step S132), or if it is judged that an operation for setting display on the display 141 to an ON state has been performed (if judged YES at step S133), the control unit 110, at step S134, transmits a control signal to the display unit 140 such that display items for when the user has stopped are displayed on the display 141. The display items for when the user has stopped are, for example, step count and time.

Returning to FIG. 1, “10568 steps” and “13:15”, for example, as the step count and time, respectively, are displayed on the display 141 of the activity monitor 100 as a result of step S134 being executed.

Proceeding to FIG. 4, if it is judged that the physical activity state flag of the user does not indicate “stopped” (if judged NO at step S131), the control unit 110, at step S141, judges whether the physical activity state flag of the user set at step S110 indicates “walking”.

If it is judged that “walking” is indicated (if judged YES at step S141), the control unit 110, at step S142, judges whether the prescribed posture start flag was set to an ON state at step S120, or in other words, whether the start of the prescribed posture has been detected.

If it is judged that the start of the prescribed posture has been detected (if judged YES at step S142), the control unit 110, at step S143, transmits a control signal to the display unit 140 so that display items for when the user is walking are displayed on the display 141. The display items for when the user is walking are, for example, step count and burned calories or walk time,

If it is judged that the physical activity state flag of the user does not indicate “walking” (if judged NO at step S141), or in other words, if the state of physical activity of the user is “running”, the control unit 110, at step S151, judges whether the prescribed posture start flag was set to an ON state at step S120, or in other words, whether the start of the prescribed posture has been detected.

If it is judged that the start of the prescribed posture has been detected (if judged YES at step S151), the control unit 110, at step S152, transmits a control signal to the display unit 140 so that display items for when the user is running are displayed on the display 141. The display items for when the user is running are, for example, average speed and burned calories or remaining burned calories to a target value.

If it is judged that an operation for setting display on the display 141 to an ON state has not been performed (if judged NO at step S133), or after step S134, or if it is judged that the start of the prescribed posture has not been detected (if judged NO at step S142 or step S151), or after step S143 or step S152, the control unit 110 proceeds to step S161.

At step S161, the control unit 110 judges whether an operation for switching the display contents of the display 141 has been performed, by judging whether an operation signal indicating that the change display/setting switch 131 was operated by the user has been input from the operation unit 130 to the control unit 110,

If it is judged that an operation for switching the display contents of the display 141 has been performed (if judged YES at step S161), the control unit 110, at step S162, transmits a control signal to the display unit 140 so that the display items switched to are displayed.

For example, one or more of the following types of information are sequentially switched to and displayed each time an operation for switching the display contents is performed: time from the start of physical activity, distance from the start of physical activity, calories burned from the start of physical activity, average speed from the start of physical activity, EX amount from the start of physical activity, step count for the day, travel distance for the day, calories burned for the day, amount of fat burned for the day.

If it is judged that an operation for switching the display contents of the display 141 has not been performed (if judged NO at step S161), or after step S162, the control unit 110, at step S171, judges whether the prescribed posture end flag was set to an ON state at step S120, or in other words, whether the end of the prescribed posture has been detected.

If it is judged that the end of the prescribed posture has not been detected (if judged NO at step S171), the control unit 110, at step S172, judges whether an operation for setting display on the display 141 to an OFF state has been performed, by judging whether an operation signal indicating that the down-operation/delete switch 133 was operated by the user has been input from the operation unit 130 to the control unit 110.

If it is judged that an operation for setting display on the display 141 to an OFF state has not been performed (if judged NO at step S172), the control unit 110, at step S173, judges whether a prescribed number of minutes (e.g., 1 min.) has elapsed since display on the display 141 was set to an ON state in step S134, step S143, step S152 or step S162.

If it is judged that the end of the prescribed posture has been detected (if judged YES at step S171), or if it is judged that an operation for setting display on the display 141 to an OFF state has been performed (if judged YES at step S172), or if it is judged that the prescribed number of minutes has elapsed since display on the display 141 was set to an ON state (if judged YES at step S173), the control unit 110, at step S174, transmits a control signal to the display unit 140 so that display on the display 141 is set to an OFF state.

On the other hand, if the end of the prescribed posture has not been detected, if an operation for setting display on the display 141 to an OFF state has not been performed, and if it is judged that the prescribed number of minutes has not elapsed since display on the display 141 was set to an ON state (if judged NO at step S173), the control unit 110 returns to the processing from which this display processing was originally called.

### Second Embodiment

In the second embodiment, a part of the posture change detection processing illustrated in FIG. 6 of the first embodiment is changed. Because the other parts are thus in common with the first embodiment, redundant description will not be repeated.

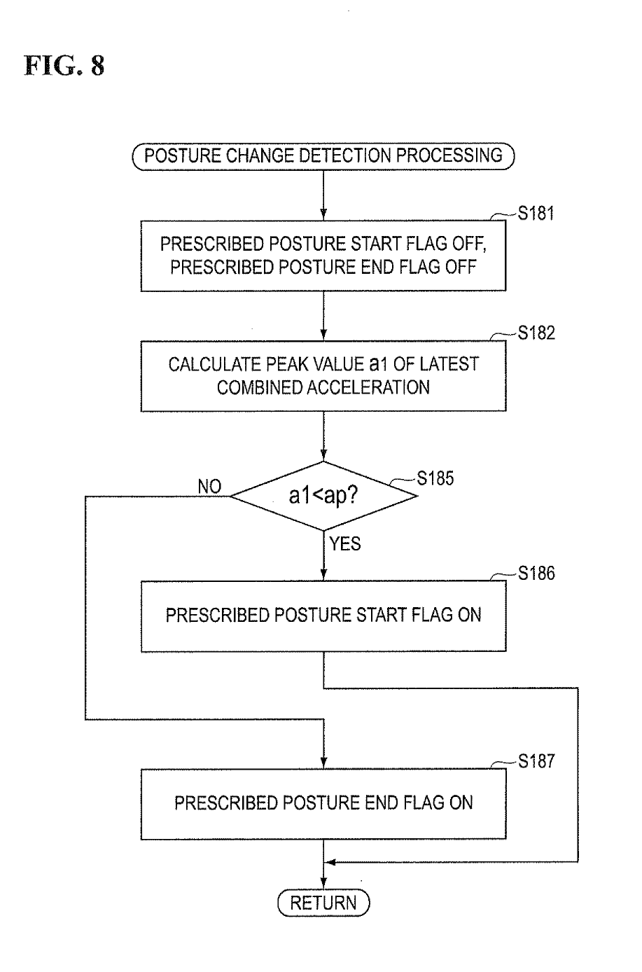

FIG. 8 is a flowchart showing the flow of posture change detection processing executed by the activity monitor in the second embodiment. Referring to FIG. 8, step S181 is similar to step S121 of FIG. 6.

At the following step S182, the control unit 110 calculates a peak value a1 of the latest combined acceleration of the three axes, based on detection values from the acceleration sensor 170.

In a state in which the user is swinging his arms when jogging, without checking the contents displayed on the display 141 of the activity monitor 100, as shown in the aforementioned FIG. 2A, there will be more arm movement and the combined acceleration value of acceleration in the three axis directions will be greater, as compared with a state in which the user is checking the contents displayed on the display 141 of the activity monitor 100 when jogging, as shown in the aforementioned FIG. 2B.

If a representative value (e.g., peak value, average value of one cycle, etc.) of the combined acceleration in three axis directions is less than or equal to a prescribed value ap at which it can be judged that arm movement has been reduced and the user is checking the contents displayed on the display 141 of the activity monitor 100, it can thus be judged that the user has changed to the prescribed posture for viewing the display 141 of the activity monitor 100, as shown in the aforementioned FIG. 2B.

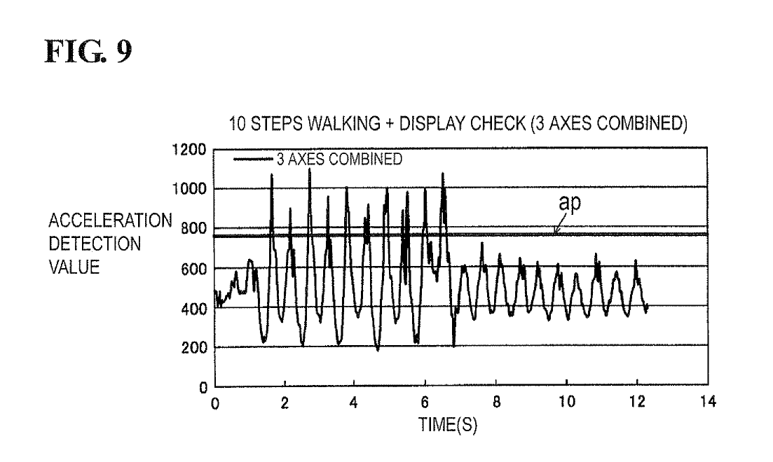

At step S185, the control unit 110 judges whether the peak value a1 of the latest combined acceleration is less than or equal to the prescribed value ap (in the present embodiment, 750 in the detection values of the acceleration sensor 170 which is the index on the vertical axis of the graph of FIG. 9).

FIG. 9 is a graph showing the change in combined acceleration in the use state of the activity monitor in the second embodiment. Referring to FIG. 9, this graph shows the change in combined acceleration obtained by combining the acceleration in the three axis directions of the graph illustrated in FIG. 7.

It is clear that when the user is jogging without checking display on the display 141 of the activity monitor 100 from 0 seconds to approximately 7 seconds, the peak value a1 of the combined acceleration is constantly greater than or equal to the prescribed value ap (in the present embodiment, 750), whereas when the user checks display on the display 141 of the activity monitor 100 while jogging from approximately 7 seconds onward, the peak value a1 of combined acceleration is always less than the prescribed value ap.

Returning to FIG. 8, if it is judged that the peak value a1 of combined acceleration is less than or equal to the prescribed value ap (if judged YES at step S185), the control unit 110, at step S186, sets the prescribed posture start flag to an ON state. Thereafter, the control unit 110 returns to the display processing from which this posture change detection processing was originally called.

If it is judged that the peak value a1 of combined acceleration is not less than or equal to the prescribed value ap (if judged NO at step S185), the control unit 110, at step S187, sets the prescribed posture end flag to an ON state. Thereafter, the control unit 110 returns to the display processing from which this posture change detection processing was originally called.

Note that, here, it is judged whether the prescribed posture has started or ended, depending on whether the peak value of the latest combined acceleration is less than or equal to a prescribed value. However, the present invention is not limited thereto, and a configuration may be adopted in which it is judged whether the average value of combined acceleration for the last few cycles (e.g., one cycle (one step) or a plurality of cycles (plurality of steps)) is greater than or equal to a prescribed value.

### Third Embodiment

In a third Embodiment, a part of the posture change detection processing illustrated in FIG. 6 of the first embodiment is changed. Because the other parts are thus in common with the first embodiment, redundant description will not be repeated.

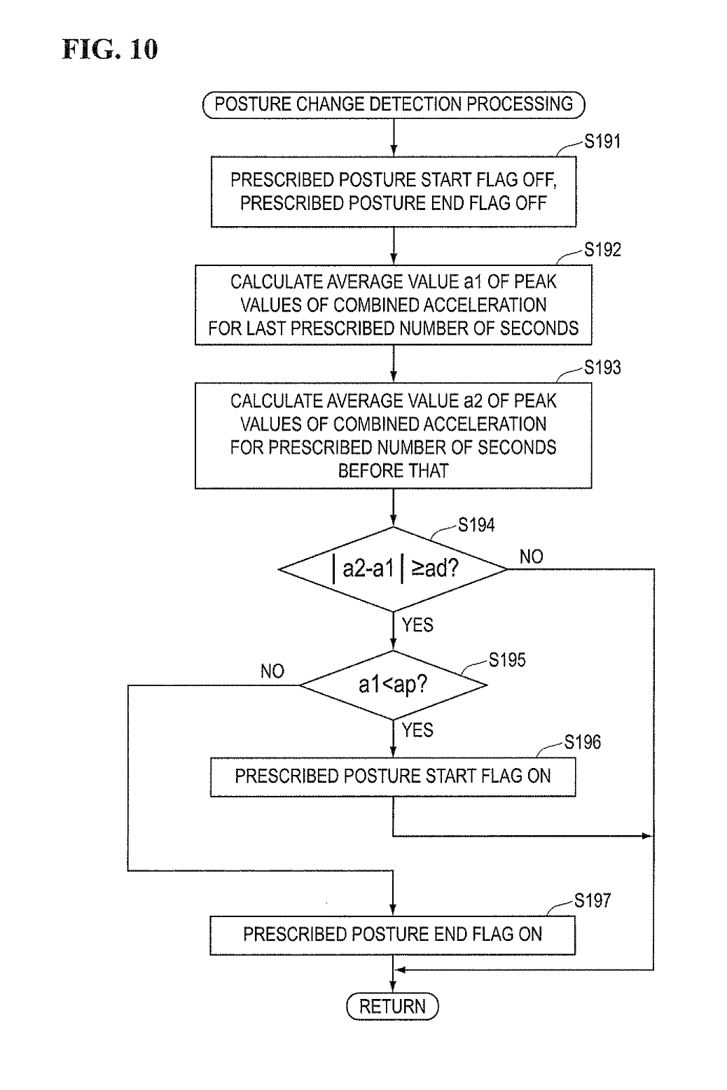

FIG. 10 is a flowchart showing the flow of posture change detection processing executed by the activity monitor in the third embodiment. Referring to FIG. 10, step S191 is similar to step S121 of FIG. 6.

At the following step S192, the control unit 110 calculates an average value a1 of the peak values of combined acceleration for the last prescribed number of seconds (e.g., for 2 seconds from 2 seconds before to the current time), based on detection values from the acceleration sensor 170.

Also, at step S193, the control unit 110 calculates an average value a2 of the peak values of combined acceleration for the prescribed number of seconds before that (e.g., for 2 seconds from 4 seconds before to 2 seconds before), based on detection values from the acceleration sensor 170. Note that the detection values of acceleration for the last prescribed number of seconds and the prescribed number of seconds before that are stored in the memory 120.

At step S194, the control unit 110 judges whether the absolute value of the difference between the average values a2 and a1 of the peak values of combined acceleration is greater than or equal to a prescribed value ad. In other words, it is judged whether the average value of the peak values of combined acceleration has changed significantly (greater than or equal to the prescribed value ad), by comparing the last prescribed number of seconds with the prescribed number of seconds before that. It is conceivable that the timing at which the average value of the peak values of combined acceleration changes significantly is the timing at which there was some sort of change in posture.

If it is judged that the absolute value of the difference between the average values a2 and a1 of the peak values of combined acceleration is greater than or equal to the prescribed value ad (if judged YES at step S194), it is judged, at step S195, whether the peak value a1 of the latest combined acceleration is less than or equal to a prescribed value ap (in the present embodiment, 750 in the detection values of the acceleration sensor 170 which is the index on the vertical axis of the graph of FIG. 9).

If it is judged that the peak value a1 of combined acceleration is less than or equal to the prescribed value ap (if judged YES at step S195), the control unit 110, at step S196, sets the prescribed posture start flag to an ON state. Thereafter, the control unit 110 returns to the display processing from which this posture change detection processing was originally called.

If it is judged that the peak value a1 of combined acceleration is not less than or equal to the prescribed value ap (if judged NO at step S195), the control unit 110, at step S197, sets the prescribed posture end flag to an ON state. Thereafter, the control unit 110 returns to the display processing from which this posture change detection processing was originally called.

In other words, it can be judged that the prescribed posture has started, in the case where, from step S194 to step S197, it is judged that the average value of the peak values of combined acceleration has changed significantly and it is judged that the peak value of combined acceleration is small. On the other hand, it can be judged that the prescribed posture has ended, in the case where it is judged that the average value of the peak values of combined acceleration has changed significantly and it is not judged that the peak value of combined acceleration is small.

Note that at step S192 and step S193 of FIG. 10, respectively, it is judged whether the prescribed posture has started or ended, based on the average value of the peak values of combined acceleration for the last prescribed number of seconds and the average value of the peak values of combined acceleration for the prescribed number of seconds before that.

However, the present invention is not limited thereto, and a configuration may be adopted in which the judgment is performed based on the average value of the peak values of combined acceleration for the two latest cycles and the average value of the peak value of the combined acceleration for the two cycles before that. Also, instead of judging based on the average value of the peak values of combined acceleration, a configuration may be adopted in which the judgment is performed based on the average value of combined acceleration for the last few cycles (e.g., 1 cycle (1 step) or a plurality of cycles (plurality of steps)).

Next, modifications of the abovementioned embodiments will be described. (1) In the aforementioned embodiments, a change by the user to the prescribed posture for viewing the display 141 of the activity monitor 100 was judged based on a predetermined condition.

However, the present invention is not limited thereto, and the activity monitor 100 may be configured to actually measure the respective detection values of the acceleration sensor 170 using the activity monitor 100, when the user starts the prescribed posture for viewing the display 141, or is maintaining the prescribed posture, or ends the prescribed posture, to calculate a threshold for judgment values based on acceleration that differs for each user from these detection values, and to be able to detect a change in the prescribed posture using the calculated threshold.

(2) In the aforementioned embodiments, the activity monitor 100 exhibited prescribed functions as a result of the processing from FIG. 4 to FIG. 6, the processing of FIG. 8, and the processing of FIG. 10 being executed by the control unit 110. However, the present invention is not limited thereto, and a configuration may be adopted in which prescribed functions exhibited as a result of the processing of this software being executed are exhibited by hardware circuitry.

(3) In the aforementioned embodiments, the invention was described as being devices of the activity monitor 100. However, the present invention is not limited thereto, and a configuration may be adopted in which the invention is regarded as a method executed by devices of the activity monitor 100, or as a program executed by devices of the activity monitor 100.

(4) In the aforementioned embodiments, the triaxial acceleration sensor 170 was used. However, the present invention is not limited thereto, and a configuration may be adopted in which a single-axis or biaxial acceleration sensor is used, as long as similar judgments can be performed based on the detection values of an acceleration sensor.

(5) In the aforementioned embodiments, in order to detect a change by the user to the prescribed posture for viewing the display 141, the activity monitor 100 is worn on the arm of the user. However, the present invention is not limited thereto, and a configuration may be adopted in which a change to a prescribed posture is detected based on the change in acceleration detected by the acceleration sensor 170 in the case where the activity monitor 100 is worn somewhere else.

(6) In the aforementioned embodiments, as illustrated in FIG. 4, when a change by the user to the prescribed posture for viewing the display 141 is detected, the display state of the display 141 is switched to a display state appropriate to the discriminated state of physical activity.

However, the present invention is not limited thereto, and any configuration in which the display state of the display 141 is switched based on discrimination of the movement state (state of physical activity or posture) using acceleration may be adopted.

For example, a configuration may be adopted in which the display state of the display 141 changes to a display state appropriate to the state of physical activity or posture discriminated using acceleration, irrespective of a change to the prescribed posture or a change in the state of physical activity. Specifically, when a display operation is performed by the user, the display state of the display 141 changes to a display state appropriate to the state of physical activity discriminated using acceleration. Display can thereby be automatically switched to display appropriate to the movement state.

Also, a configuration may be adopted in which, when a change in the state of physical activity or a change in posture is detected using acceleration, the display state is switched to a display state that is unrelated to the changed state of physical activity or posture, rather than switching to a display state appropriate to the changed state of physical activity or posture.

Specifically, a configuration may be adopted in which, when a change by the user to the prescribed posture for viewing the display 141 is detected using acceleration, the display state is change to a display state displaying only items such as time or the like that are unrelated to the state of physical activity or the posture, rather than items such as step count or the like that depend on the state of physical activity or posture. Display can thereby be switched automatically when the movement state changes.

(7) In the aforementioned embodiments, the state of physical activity is discriminated according to the number of the peaks of the acceleration waveform per prescribed time period. However, the present invention is not limited thereto, and as long as movement states such as the state of physical activity and posture are distinguished according to an acceleration waveform, a configuration may be adopted in which the movement states are distinguished according to the peak value of acceleration, the pitch of acceleration, or the angle of the main body unit 191 judged from acceleration, for example.

(8) The embodiments disclosed herein are to be considered in all respects as illustrative and not restrictive. The technical scope of the invention is defined by the claims, and all changes that come within the meaning and range of equivalency of the claims are intended to be embraced therein.

### REFERENCE SIGNS LIST

100 activity meter
110 control unit
120 memory
130 operation unit
131 change display/setting switch
132 up-operation/memory switch
133 down-operation/delete switch
140 display unit
141 display
170 acceleration sensor
190 power source
191 main body unit
192 band

1. A body movement detection device comprising:
a main body unit;
a display unit provided to the main body unit;
a control unit; and
a detection unit that detects acceleration of the main body unit,
wherein the control unit includes:
discriminating unit that discriminates a movement state of a user wearing the main body unit, based on the acceleration detected by the detection unit;
display control unit that switches a display state of the display unit based on discrimination of the movement state by the discriminating unit; and
posture detecting unit that detects a change by the user to a prescribed posture for viewing the display unit, based on the acceleration detected by the detection unit, and
the discriminating mean unit discriminates that the movement state has changed, when a change to the prescribed posture is detected by the posture detecting unit, and
the display control unit switches the display state of the display unit in a case where it is discriminated by the discriminating unit that the movement state has changed.

2. The body movement detection device according to claim 1,
wherein the posture detecting unit further detects a change from the prescribed posture to another posture, based on the acceleration detected by the detection unit unit, and
the display control unit further switches the display state to a non-display state when a change to the other posture is detected by the posture detecting unit.

3. The body movement detection device according to claim 1,
wherein the detection unit further detects acceleration in a direction in which an influence of gravitational acceleration is greater when the user is in the prescribed posture than when the user is in another posture, and
the posture detecting unit detects a change to the prescribed posture, when the acceleration detected by the detection unit satisfies a condition enabling it to be judged that the influence of gravitational acceleration is greater.

4. The body movement detection device according to claim 1,
wherein the detection unit detects acceleration in two or three axis directions, and
the posture detecting unit detects a change to the prescribed posture, when a condition enabling it to be judged that a representative value of combined acceleration obtained by combining the acceleration in the two or three axis directions detected by the detection unit is less than a prescribed value is satisfied.

5. The body movement detection device according to claim 1,
wherein the display control unit switches the display state of the display unit to a display state appropriate to the movement state discriminated by the discriminating unit.

6. The body movement detection device according to claim 5,
wherein the movement state is a state of physical activity,
the discriminating unit discriminates a running state, a walking state or a stopped state as the state of physical activity, and
the display control unit switches to display suitable for when the user is running in a case where the state of physical activity discriminated by the discriminating unit is the running state, switches to display suitable for when the user is walking in a case where the state of physical activity discriminated by the discriminating unit is the walking state, and switches to display suitable for when the user has stopped in a case where the state of physical activity discriminated by the discriminating unit is the stopped state.

7. The body movement detection device according to claim 1,
wherein the discriminating unit discriminates the movement state, according to a waveform of the acceleration.

8. A display control method for switching a display state of a display unit of a body movement detection device that includes a main body unit, the display unit which is provided to the main body unit, a control unit and a detection unit that detects acceleration of the main body unit, comprising the steps of:
the control unit discriminating a movement state of a user wearing the main body unit, based on the acceleration detected by the detection unit;
the control unit switching the display state of the display unit, based on discrimination of the movement state; and
detecting a change by the user to a prescribed posture for viewing the display unit, based on the acceleration detected by the detection unit,
wherein the step of discriminating the movement state includes the step of discriminating that the movement state has changed, when a change to the prescribed posture is detected, and
the step of switching the display state includes the step of switching the display state of the display unit in a case where it is discriminated that the movement state changed.
